(19) United States
(12) Patent Application Publication
(10) Pub. No.: US 2021/0241134 A1
(43) Pub. Date: Aug. 5, 2021

(54) IDENTIFYING MESSAGE THREAD STATE

(71) Applicant: salesforce.com, inc., San Francisco, CA (US)

(72) Inventors: Noah William Burbank, Palo Alto, CA (US); Narek Asadorian, San Francisco, CA (US)

(21) Appl. No.: 16/779,050

(22) Filed: Jan. 31, 2020

(51) Int. Cl. G06N 5/04; G06F 16/23; G06N 20/00; G06F 16/2455

(52) U.S. Cl. CPC G06N 5/04; G06F 16/24568; G06N 20/00; G06F 16/2379

(57) ABSTRACT

A communications system may utilize the machine learning model in association with the finite state machine to determine whether a new message (e.g., email) corresponds to a state transition for the message thread. As such, the model may be trained on a corpus of message thread data, and may be configured to identify one of a plurality of message thread states of the finite state machine in accordance with the training. As various messages are exchanged between various users, the thread state of the corresponding message thread may be updated using the finite state machine and the machine learning model. The updates to the thread state may trigger various automated actions as well as indications to one or more users of the system.

### FIELD OF TECHNOLOGY

The present disclosure relates generally to database systems and data processing, and more specifically to identifying message thread state.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

A user of a CRM application may utilize email systems and or various task management services to monitor workflow, communication requirements, etc. These systems may require the user to manually input information and/or track communications with various other contacts. Thus, the user may be required to monitor various systems. Automated task systems may not be able to access and/or process the various data sources and identify the actions for a user, since the data may be distributed among various systems and not structured for ingestion by such a system.

### BRIEF DESCRIPTION OF THE DRAWINGS

FIG. 1 illustrates an example of a system for data processing that supports identifying message thread state in accordance with aspects of the present disclosure.

FIG. 2 illustrates an example of a computing system that supports identifying message thread state in accordance with aspects of the present disclosure.

FIG. 3 illustrates an example of a finite state machine that supports identifying message thread state in accordance with aspects of the present disclosure.

FIG. 4 illustrates an example of a process flow diagram that supports identifying message thread state in accordance with aspects of the present disclosure.

FIG. 5 shows a block diagram of an apparatus that supports identifying message thread state in accordance with aspects of the present disclosure.

FIG. 6 shows a block diagram of a message thread state manager that supports identifying message thread state in accordance with aspects of the present disclosure.

FIG. 7 shows a diagram of a system including a device that supports identifying message thread state in accordance with aspects of the present disclosure.

FIGS. 8 through 10 show flowcharts illustrating methods that support identifying message thread state in accordance with aspects of the present disclosure.

### DETAILED DESCRIPTION

Aspects of the disclosure described herein may provide an automated communication ingestion and monitoring service to support action identification for a user. The system may manage layered threads of communications (e.g., emails, texts, phone call transcripts, chat transcripts) between various users of the system and contacts external to the system. The system may utilize a finite state machine and a machine learning model to identify a thread state of a message thread. The thread state may indicate whether an action may be needed by one of the users. For example, an external contact may request information, a service, a product, or the like from a user of the system via email. The system may detect the email, identify a message thread associated with the message, and determine a new thread state for the message thread based on the new email. The thread state may indicate that an action (e.g., a response to the request) is needed by the user.

The system may utilize the machine learning model in association with the finite state machine to determine whether a new message (e.g., email) corresponds to a state transition for the message thread. As such, the model may be trained on a corpus of message thread data and may be configured to identify one of a plurality of message thread states of the finite state machine in accordance with the training. As various messages are exchanged between various users, the thread state of the corresponding message thread may be updated using the finite state machine and the machine learning model. The updates to the thread state may trigger various automated actions as well as indications to one or more users of the system.

In some examples, the thread states may correspond to start, open, delivered, and acknowledged. When a thread is in an open state, the system may have identified that a user made a request for some information to a user of the system. An open state thread may be associated with a high priority for an action by a user. As such, the system may trigger a notification to the user in response to the thread state being open, the thread state being open for some amount of time, etc. As such, the described system may monitor time periods that threads are associated with states, users associated with the threads, etc. Accordingly, a manager may utilize the system to monitor communication metrics for various other users of the system.

Aspects of the disclosure are initially described in the context of an environment supporting an on-demand database service. Aspects of the disclosure are further described with respect to a computing system illustrating various data flows to enable thread state identification, a finite state machine, and a process flow diagram. Aspects of the disclosure are further illustrated by and described with reference to apparatus diagrams, system diagrams, and flowcharts that relate to identifying message thread state.

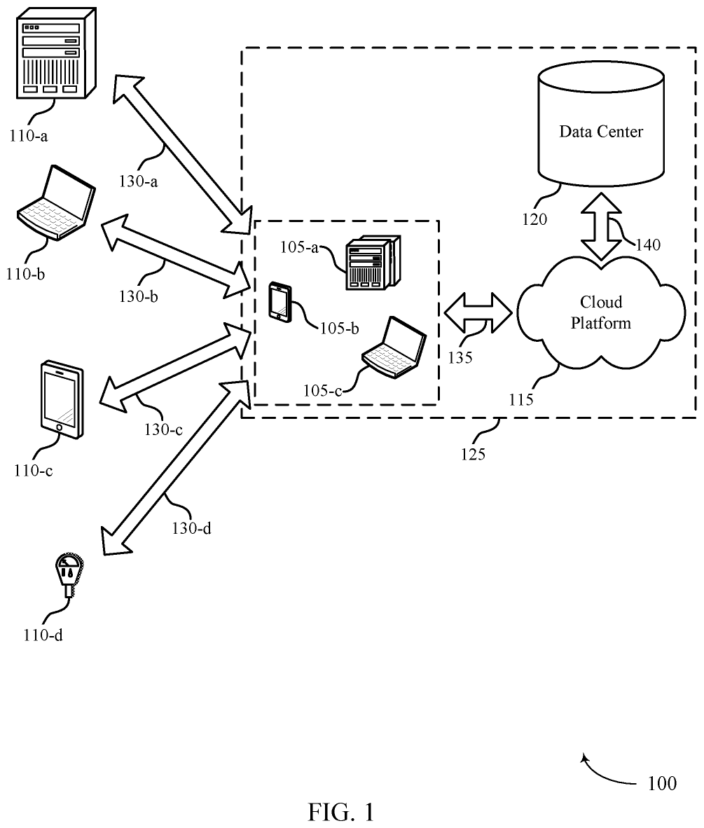

FIG. 1 illustrates an example of a system 100 for cloud computing that supports identifying message thread state in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to some applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The cloud platform 115 may support or have access to various communication systems. For example, the cloud platform 115 may access or support an email server, a chat service, a phone system, a message system, etc. In some examples, the cloud platform 115 provides an email server and accesses other communication services, such as a phone system, message system (e.g., a client device supported messaging system), a social media platform, and/or other communications systems. In some examples, the cloud platform 115 may access the various systems using application programming interfaces (APIs) or other connections, such as a data streaming connection. In some examples, the communication system supported by the cloud platform 115 may batch request communication data from various sources, combine the batch data with other data (such as streaming connection data), and organize/monitor the data to provide various services. The cloud platform may also support a message thread state manager, which analyzes messages of one or more of the described systems, identifies message thread states, and may identify one or more actions for a user based on the message thread state.

Some communications systems are siloed, in that each form of communication is supported by a separate system. These separate systems may not be accessible to external systems. These siloed systems may also prevent or hinder a complete analysis of communications by a user, which may result in an inaccurate communication analysis. Further, some communications systems may provide automated analysis of a communication to provide status updates to the users, but these status updates are based on a single communication (e.g., one email), and thus may not provide an accurate status update.

Aspects of the communication system supported by the cloud platform 115 described herein may access various communications by various users of the cloud platform 115 as well as users external to the cloud platform 115. The system may maintain detailed and multi-layered threads of communications, such as email communications. The threads may be maintained with reference to one or more users to a communication, such that a thread may be retrieved with reference to one or more of the users. The system may also maintain a thread state for each thread, and the thread state may be maintained with reference to various user's perspectives relative to the thread. The system may utilize a finite state machine and a machine learning system to identify a thread state. For example, when a new message is detected (e.g., using a streaming connection), the system may retrieve a thread associated with the message and analyze the message, the retrieved thread, and/or the state associated with the message to determine whether a state transition has occurred (e.g., using the model and with reference to the finite state machine). Accordingly, because the system uses contextual data (e.g., message thread and prior state), the system may provide a richer status analysis and update relative to prior systems. Further, the model may identify one or more actions for a user based on an identified state transition.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

A salesperson may utilize a CRM system supported by the cloud platform to support a high-velocity (e.g., high volume) sales. The salesperson may communicate with various customers and prospective customers (e.g., a contact 110) using emails. In some cases, the contact 110 may request information from the salesperson via email. The system detects the new email from the contact 110, analyzes the new message as well as a thread and the associated thread state corresponding to communications between the salesperson and the contact 110. The system may identify that the email includes a request for information (e.g., based on NLP processing by the model supported by the cloud platform 115) and identify a transition between states of a finite state machine. The system may transmit an indication to the salesperson and/or automatically identify an action for responding to the request. The action may include providing the requested information.

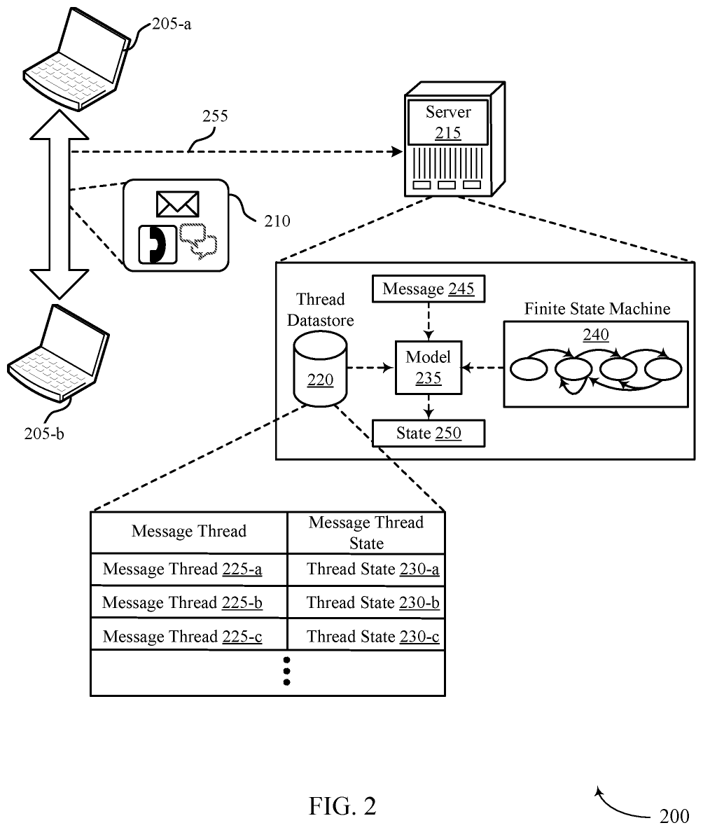

FIG. 2 illustrates an example of a system 200 that supports identifying message thread state in accordance with aspects of the present disclosure. The system 200 includes user devices 205 and a server 215. The user devices 205 may be examples of devices used by cloud clients 105 and/or contacts 110 as described with respect to FIG. 1. For example, a cloud client 105 may be associated with user device 205-a and a contact 110 may be associated with a device 205-b. The server 215 may represent various aspects of the cloud platform 115 and/or data center 120 of FIG. 1, and may comprise one or more computing systems, which may be logically or physically distributed.

The server 215 may monitor and process communications 210 between user devices 205, other user devices, etc. In some cases, the server 215 may support or access an email server that supports email communication by one or both of the devices 205. For example, the server 215 may maintain a streaming connection 255 with an email server that supports the communication by one or both of the user devices 205. The server 215 may be configured with connections to other communication systems. For example, the server 215 may access chat application(s), social media application(s), telephonic systems, etc. associated with users of one or more of the user devices 205. In some examples, the server 215 may access such systems using streaming connections, APIs, etc.

The server 215 and/or associated systems may maintain a thread datastore 220, which stores a plurality of message threads 225 and thread states 230 associated with respective message threads 225. As noted herein, the message threads 225 may be stored using a complex and layered technique, such that a message thread associated with two or more users may be efficiently stored and retrieved. A message thread 225 may include a plurality of communications between users to a thread. In some examples, a message thread 225 may be associated with one particular type of communication 210, such as email. In other cases, a message thread 225 may include a plurality of communication types, such as emails, phone calls, chat service/application communications, text messages, and the like. In the case of the phone call, a system associated with or supporting a phone system may transcribe communications between various users of the system, such that the communication 210 may be stored in a message thread 225 and/or processed by associated systems, such as the message state system as described herein.

The server 215 may utilize a machine learning model 235 in conjunction with a finite state machine 240 to determine thread states of message threads 225. The finite state machine 240 may represent an abstraction of a set of instructions that are used with the machine learning model 235 to identify message thread states 230 and transitions between thread states. For example, the model 235 may analyze a new message 245 (e.g., a communication 210), the associated message thread 225, and the current thread state 230. The model 235 may identify that the new message 245 includes a request and that the prior thread state 230-a is “start.” Based on the message thread state 230 being start and identifying the request, the system may identify that a transition to an open thread state 230-a occurs based on the new message 245. That is, regarding the finite state machine 240, the message thread state 230 transitions on a path between a start state and an open state.

To identify that the new message 245 includes a request or other type of communication, the machine learning model 235 may perform various natural language processing techniques and may be trained to identify that the message includes a request. The model 235 may use similar techniques to identify that a new message 245 corresponds to a response, an acknowledgment, etc. In some examples, the model 235 is configured to featurize one or more prior messages of the message thread as well as the new message 245 to identify characteristics of the new message 245 (e.g., whether the new message includes a request). Featurization may include converting the text of the message, metadata associated with the message, etc. into a vector of predefined length. In some examples, the text of the message is featurized and separate sentences are featurized separately. As such, a sentence may be determined to be a request, while the message is determined to contain a request. The featurized message may be compared to other labeled messages (e.g., labeled with a request, response, etc.) to determine whether the message corresponds to such data.

In some examples, the model 235 outputs confidence scores associated a message classification. For example, the model 235 may output a first confidence score associated with a request classification, a second confidence score associated with a delivered classification, and a third confidence score associated with an acknowledgement classification. Whether or not the model outputs a confidence score for a particular classification may depend on satisfaction of a threshold (e.g., a relatively high degree of confidence). The system may utilize the confidence scores as well as the prior thread states to determine the updated thread state 250 associated with the new message and the message thread.

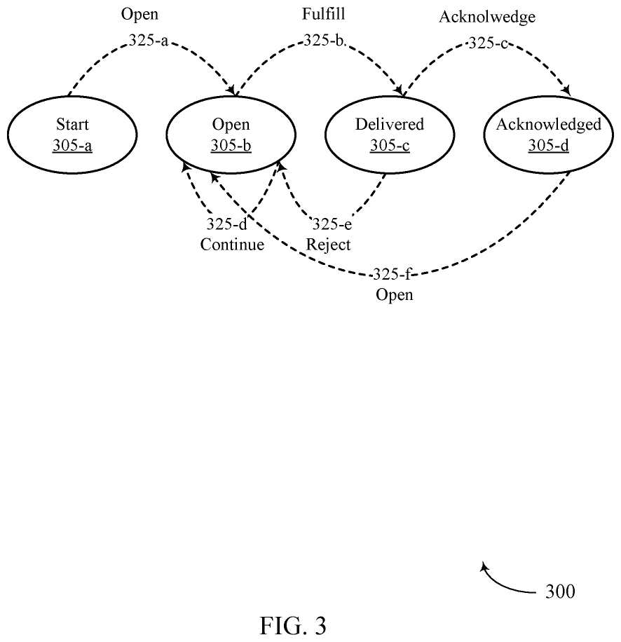

FIG. 3 illustrates an example of a finite state machine 300 that supports identifying message thread state in accordance with aspects of the present disclosure. The finite state machine 300 may be used in conjunction with a machine learning model, such as machine learning model 235 of FIG. 2, to process messages, identify thread states, and or identify actions based on identified thread states. In some examples, the finite state machine 300 may be implemented by aspects of FIG. 1, such as the cloud platform 115 and/or data center 120, and aspects of FIG. 2, such as the server 215.

The finite state machine 300 may represent an abstraction of a set of instructions that may be used to associate a thread state with a message thread. The instructions of the finite state machine 300 may receive an output by the machine learning model and determine whether a state transition 325 between thread states has occurred. The finite state machine 300 includes a set of message thread states 305. The thread states 305 include a start state 305-a, an open state 305-b, a delivered state 305-c, an acknowledged state 305-d. It should be understood that other states are contemplated for various different circumstances.

A message thread may be designated a start state 305-a based on various circumstances. For example, a thread may be given a start state 305-a when a first outbound message is transmitted from one or more external users. More particularly, every message or thread may not be given a state. For example, messages transmitted between internal users may not be monitored for thread states. However, a message transmitted by external users (e.g., to internal users) may be monitored and a start state 305-a may be designated to such external messages. In some examples, the model 235 analyzes the message to determine whether the message includes an offer (e.g., an offer for a service or product), and if the model determines that the external message includes an offer with some degree of confidence (e.g., a confidence above a threshold), then the message thread may be designed with the start state 305-a.

If a contact (e.g., a contact 110 of FIG. 1) or a user to a thread responds to thread (e.g., with a new message) that is in a start state 305-a with a request, such as “can you send me the updated contract?”, then a state transition 325-a may occur such as the thread state is updated the open state 305-b. The machine learning model may analyze the new message to identify that the message includes a request. In some cases, the model may output a classification of the message as a request with a confidence score. The transition 325-a may be identified when the request is identified with some level of confidence (e.g., over a threshold).

A user, such as a cloud client 105 of FIG. 1, may respond to the request with a message that includes the requested information as well as some affirmation, such as “here it is.” The model may identify that the new message includes the information, the affirmation, a fulfillment, or a combination thereof. In some examples, because the message thread is in an open state 305-b (e.g., based on the prior request), the model may identify that the response fulfills the request by providing greater weight to a confidence score associated with a response/fulfillment classification. That is, a response is likely to follow a request, and thus is provided greater weight in an NLP analysis. Based on identifying that the new message fulfills the request, the system may identify that a transition 325-b occurs, and the message thread is assigned a delivered state 305-c.

A user may transmit a message in response to a fulfillment. In one example, the message may correspond to an acknowledgement of the fulfillment, such as “got it, thanks.” In such cases, the thread may be updated to an acknowledged state 305-d based on a transition 425-c. More particularly, the model may identify an acknowledgment in the message, and the thread state may be updated in accordance with the transition 325-c. However, in some examples, a user may reject the response. For example, in response to receiving contract information, the user may transmit a message including the text “This is the old one, I need the updated one.” The model may identify that this is a rejection based on the text as well as the context (e.g., thread state and/or previous message in the thread) associated with the message including the text. In response to identifying a rejection, transition 325-e may occur, and the thread state may be updated to the open state 305-b.

While the thread state is in the open state 305-b, the user that transmitted the request (e.g., the request that resulted in the open state 305-b) may transit a follow up message, such as “just wanted to check on the status of the updated contract.” The model may identify that such a message includes a status request, and the system may identify that transition 325-d occurs. Thus, the state of the message thread may stay at the open state 305-b.

In some examples, after a request is acknowledged and the thread state is in an acknowledged state 305-d, one of the participants to the thread may make another request such that transition 325-f occurs and the thread state is updated to the open state 305-b. For example, after receiving a requested contract, a user may request that a meeting to discuss the updated contract be scheduled in the future. The model may identity the request, and the system may update the state to the open state 305-b. In some examples, the prior requested information may be acknowledged, and the new request be sent in the same message. For example, the new message may state “Got it, thanks! Can you schedule a meeting to go over it for next week?” In such cases, the model or system may provide greater weight to a request than an acknowledgement, and as such, the state may be updated to the open state 305-b. In other cases, two transitions may occur based on the same message. In the above discussed example, the transition 325-c may occur for the “Got it, thanks!” portion of the message, and the transition 3205-f may occur for the “Can you schedule a meeting to go over it next week?” portion of the message.

In some cases, the system may identify actions based on the transitions 325 between thread states 305. For example, a predefined set of actions may be designated for transitions, and the system may identify one or more of the actions. The actions may include notifications, auto-replies, automatic message generation, etc. For example, when a thread is updated to an open state 305-b, a notification may be transmitted to one of the participants to the thread. Since an open state 305—may correspond to a request, the open state 305-b may be associated with an action that is required by one of the users. Accordingly, a notification may be triggered (e.g., after some period of time). In another example, the action may be an automatic message generation and/or transmission. If a message corresponds to a delivery of a request, then the system may generate a response, such as “Thank you” or “received.” The response may be automatically transmitted or proposed to the user.

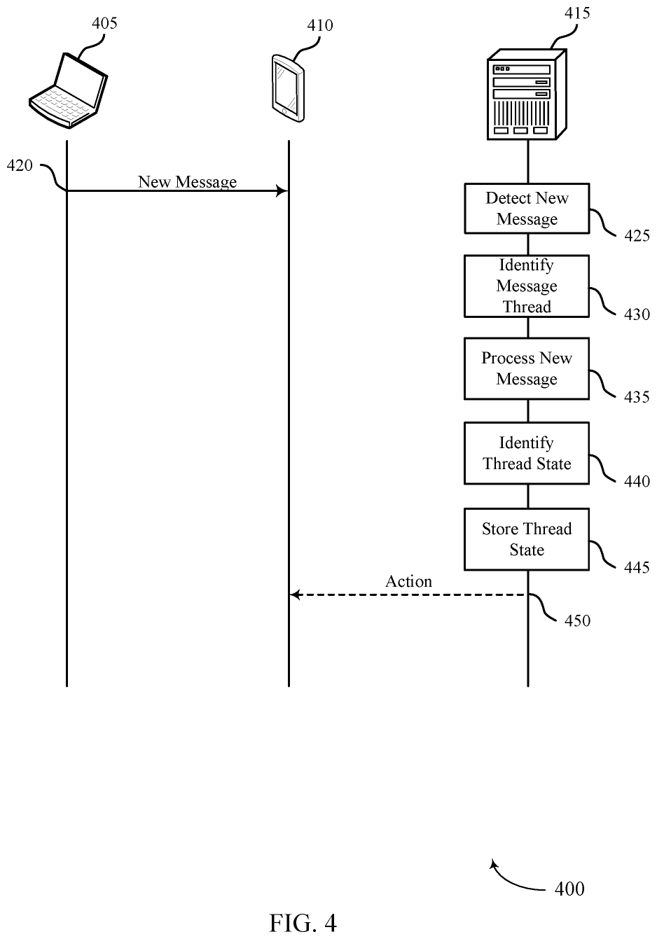

FIG. 4 illustrates an example of a process flow diagram 400 that supports identifying message thread state in accordance with aspects of the present disclosure. The process flow diagram 400 includes a user devices 405 and 410 and server 415. The user devices may be examples of the user devices 205 as described with respect to FIG. 2, and the server 420 may be an example of the server 215 as described with respect to FIG. 2.

At 420, a first user associated with the user device 410 receives a message (e.g., new message) from a second user associated with user device 405. The message may be an example of an email, a text message, a social media post, a chat application message, or the like.

At 425, the server 415 may detect, using a data stream connection, that the new message is transmitted to the first user associated with a first user identifier and by a second user associated with a second user identifier. The first and second user identifiers may be examples of email addresses, subscriber names, inferred identifiers, or the like.

At 430, the server 415 may identify, from a datastore storing a plurality of message threads, a message thread associated with the first user identifier and the second user identifier. In some cases, the message thread represents a plurality of messages transmitted between the first user and the second user. The message thread may be associated with a first thread state from a finite state machine. In some examples, the thread may be identified in accordance with the identifiers associated with the users that are participants to the message.

At 435, the server 415 may process the new message and the message thread using a machine learning model. The machine learning model is configured (e.g., trained) to identify a message thread state from the finite state machine. In some examples, the machine learning model may process the body of the message to identify whether the message corresponds to a request, a response, an acknowledgement, etc. At 440, the server 440 may identify a second thread state from the finite state machine based at least in part on processing of the new message and the message thread by the machine learning model, the first thread state, or a combination thereof. In some examples, the server 415 may determine the second thread state based on the output of the model and the prior thread state. That is, the output may identify whether the body of the message corresponds to a request, acknowledgement, response (with corresponding confidence scores), and the server 415 may identify the second thread state based at least in part on the output of the model and the prior state (e.g., the first thread state).

At 445, the server 415 may store the second thread state in association with the message thread including the new message. That is, the message thread, as stored in the data store, may be updated to include the new message. Further, the new thread state may be stored in association with the message thread.

At 450, the server may trigger one or more actions at the user device 410. In some examples, the actions are triggered based at least in part on storing the second thread state in association with the message thread. That is, a client application or server process may detect the new thread state and trigger the action at the user device 410. In one example, the action may include activation of an indication at the user device (e.g., a client device) associated with the first user based at least in part on identifying the second thread state. The indication may be an example of a notification, a user interface indication, or the like. In another example, the action may be identified from a predefined list. For example, if the new message corresponds to a delivery of requested information (e.g., the thread state is updated to delivered), then an acknowledgement action may be identified. An acknowledgement action may include generation and/or automatic transmission of an acknowledgement message.

In some cases, the server 415 maintains metrics of thread states corresponding to message threads stored in the datastore. For example, the server 415 may monitor how long a thread is in one particular state, such as an open state. If a particular thread is in an open state for a period of time (e.g., longer than some threshold period), then the server 415 may trigger a notification at a user/client device associated with one of the participants to the thread. Further, a manager may monitor various thread state statistics for various employees/users based on these metrics.

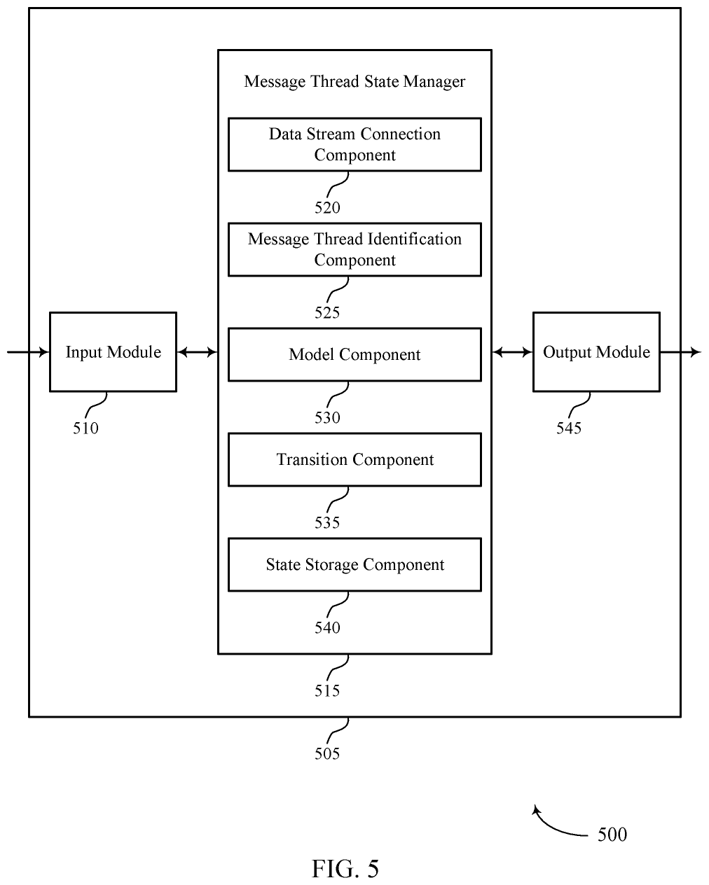

FIG. 5 shows a block diagram 500 of an apparatus 505 that supports identifying message thread state in accordance with aspects of the present disclosure. The apparatus 505 may include an input module 510, a message thread state manager 515, and an output module 545. The apparatus 505 may also include a processor. Each of these components may be in communication with one another (e.g., via one or more buses). In some cases, the apparatus 505 may be an example of a user terminal, a database server, or a system containing multiple computing devices.

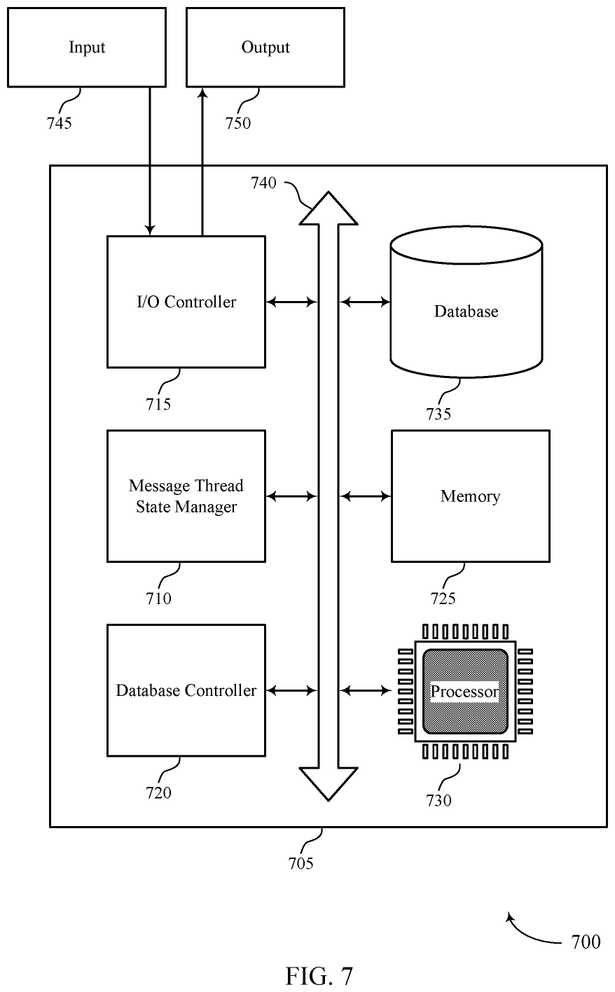

The input module 510 may manage input signals for the apparatus 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the apparatus 505 for processing. For example, the input module 510 may transmit input signals to the message thread state manager 515 to support identifying message thread state. In some cases, the input module 510 may be a component of an input/output (I/O) controller 715 as described with reference to FIG. 7.

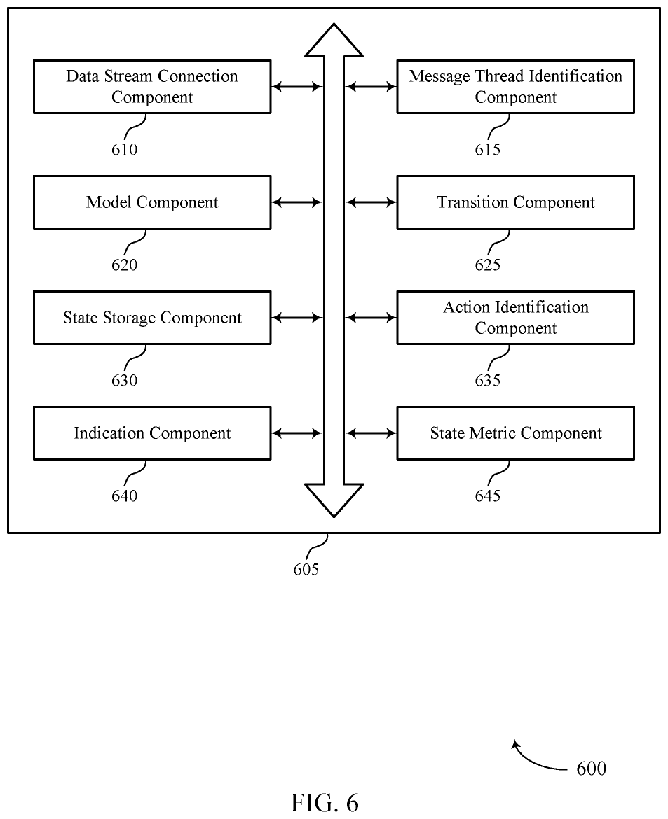

The message thread state manager 515 may include a data stream connection component 520, a message thread identification component 525, a model component 530, a transition component 535, and a state storage component 540. The message thread state manager 515 may be an example of aspects of the message thread state manager 605 or 710 described with reference to FIGS. 6 and 7.

The message thread state manager 515 and/or at least some of its various sub-components may be implemented in hardware, software executed by a processor, firmware, or any combination thereof. If implemented in software executed by a processor, the functions of the message thread state manager 515 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The message thread state manager 515 and/or at least some of its various sub-components may be physically located at various positions, including being distributed such that portions of functions are implemented at different physical locations by one or more physical devices. In some examples, the message thread state manager 515 and/or at least some of its various sub-components may be a separate and distinct component in accordance with various aspects of the present disclosure. In other examples, the message thread state manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The data stream connection component 520 may detect, using a data stream connection, that a new message is transmitted to a first user associated with a first user identifier and by a second user associated with a second user identifier.

The message thread identification component 525 may identify, from a datastore storing a set of message threads, a message thread associated with the first user identifier and the second user identifier, the message thread representing a set of messages transmitted between the first user and the second user, the message thread associated with a first thread state from a finite state machine.

The model component 530 may process the new message and the message thread using a machine learning model, the machine learning model configured to identify a message thread state from the finite state machine.

The transition component 535 may identify a second thread state from the finite state machine based on processing of the new message and the message thread by the machine learning model, the first thread state, or a combination thereof.

The state storage component 540 may store the second thread state in association with the message thread including the new message.

The output module 545 may manage output signals for the apparatus 505. For example, the output module 545 may receive signals from other components of the apparatus 505, such as the message thread state manager 515, and may transmit these signals to other components or devices. In some specific examples, the output module 545 may transmit output signals for display in a user interface, for storage in a database or data store, for further processing at a server or server cluster, or for any other processes at any number of devices or systems. In some cases, the output module 545 may be a component of an I/O controller 715 as described with reference to FIG. 7.

FIG. 6 shows a block diagram 600 of a message thread state manager 605 that supports identifying message thread state in accordance with aspects of the present disclosure. The message thread state manager 605 may be an example of aspects of a message thread state manager 515 or a message thread state manager 710 described herein. The message thread state manager 605 may include a data stream connection component 610, a message thread identification component 615, a model component 620, a transition component 625, a state storage component 630, an action identification component 635, an indication component 640, and a state metric component 645. Each of these modules may communicate, directly or indirectly, with one another (e.g., via one or more buses).

The data stream connection component 610 may detect, using a data stream connection, that a new message is transmitted to a first user associated with a first user identifier and by a second user associated with a second user identifier.

In some examples, the data stream connection component 610 may detect, using the data stream connection, that a second new message is transmitted by the first user to the second user.

In some cases, the new message corresponds to an email, a text message, a social media post, a push notification, a chat service message, a transcribed audio chat message, or a combination thereof.

In some cases, each of the set of message threads is generated based on identifying, based on processing of a first message of each of the set of message threads, that the first message has an open state.

The message thread identification component 615 may identify, from a datastore storing a set of message threads, a message thread associated with the first user identifier and the second user identifier, the message thread representing a set of messages transmitted between the first user and the second user, the message thread associated with a first thread state from a finite state machine.

The model component 620 may process the new message and the message thread using a machine learning model, the machine learning model configured to identify a message thread state from the finite state machine.

The transition component 625 may identify a second thread state from the finite state machine based on processing of the new message and the message thread by the machine learning model, the first thread state, or a combination thereof.

In some examples, identifying that the second thread state is an open state based on identifying that the new message includes a request in accordance with the processing of the new message using the machine learning model.

In some examples, identifying a third thread state from the finite state machine based on identifying that the second new message includes a response to the request in accordance with processing of the second new message and the message thread by the machine learning model.

In some examples, the transition component 625 may identify that the second thread state is one of a start state, an open state, a delivered state, and an acknowledged state.

In some cases, the third thread state is delivered based on the response to the request.

The state storage component 630 may store the second thread state in association with the message thread including the new message.

In some cases, the datastore storing the set of message threads stores the message thread state of each of the set of message threads, a time period corresponding to the message thread state, or a combination thereof.

The action identification component 635 may activate an indication at a client device associated with the first user based on identifying the second thread state.

In some examples, the action identification component 635 may identify an action from a predefined set of actions based on identifying the second thread state.

The indication component 640 may transmit an indication of the identified action to a client device associated with the first user.

In some examples, the indication component 640 may activate an indication at a client device associated with the first user based on the time period reaching a threshold associated with the second thread state.

The state metric component 645 may monitor a time period that the message thread state is associated with the second thread state.

FIG. 7 shows a diagram of a system 700 including a device 705 that supports identifying message thread state in accordance with aspects of the present disclosure. The device 705 may be an example of or include the components of an analytical data store or an apparatus 505 as described herein. The device 705 may include components for bi-directional data communications including components for transmitting and receiving communications, including a message thread state manager 710, an I/O controller 715, a database controller 720, memory 725, a processor 730, and a database 735. These components may be in electronic communication via one or more buses (e.g., bus 740).

The message thread state manager 710 may be an example of a message thread state manager 515 or 605 as described herein. For example, the message thread state manager 710 may perform any of the methods or processes described above with reference to FIGS. 5 and 6. In some cases, the message thread state manager 710 may be implemented in hardware, software executed by a processor, firmware, or any combination thereof.

The I/O controller 715 may manage input signals 745 and output signals 750 for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The database controller 720 may manage data storage and processing in a database 735. In some cases, a user may interact with the database controller 720. In other cases, the database controller 720 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause the processor to perform various functions described herein. In some cases, the memory 725 may contain, among other things, a basic input/output system (BIOS) which may control basic hardware or software operation such as the interaction with peripheral components or devices.

The processor 730 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting identifying message thread state).

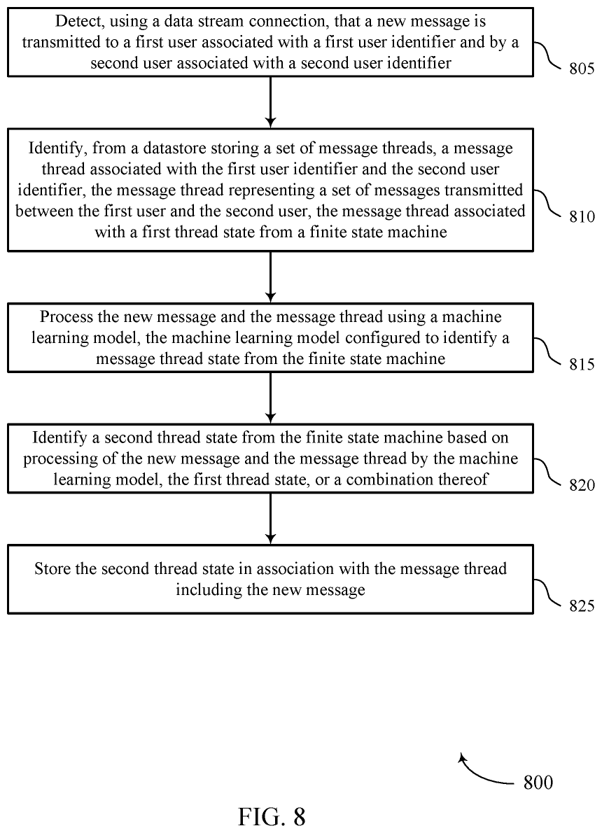

FIG. 8 shows a flowchart illustrating a method 800 that supports identifying message thread state in accordance with aspects of the present disclosure. The operations of method 800 may be implemented by an analytical data store or its components as described herein. For example, the operations of method 800 may be performed by a message thread state manager as described with reference to FIGS. 5 through 7. In some examples, an analytical data store may execute a set of instructions to control the functional elements of the analytical data store to perform the functions described below. Additionally or alternatively, an analytical data store may perform aspects of the functions described below using special-purpose hardware.

At 805, the analytical data store may detect, using a data stream connection, that a new message is transmitted to a first user associated with a first user identifier and by a second user associated with a second user identifier. The operations of 805 may be performed according to the methods described herein. In some examples, aspects of the operations of 805 may be performed by a data stream connection component as described with reference to FIGS. 5 through 7.

At 810, the analytical data store may identify, from a datastore storing a set of message threads, a message thread associated with the first user identifier and the second user identifier, the message thread representing a set of messages transmitted between the first user and the second user, the message thread associated with a first thread state from a finite state machine. The operations of 810 may be performed according to the methods described herein. In some examples, aspects of the operations of 810 may be performed by a message thread identification component as described with reference to FIGS. 5 through 7.

At 815, the analytical data store may process the new message and the message thread using a machine learning model, the machine learning model configured to identify a message thread state from the finite state machine. The operations of 815 may be performed according to the methods described herein. In some examples, aspects of the operations of 815 may be performed by a model component as described with reference to FIGS. 5 through 7.

At 820, the analytical data store may identify a second thread state from the finite state machine based on processing of the new message and the message thread by the machine learning model, the first thread state, or a combination thereof. The operations of 820 may be performed according to the methods described herein. In some examples, aspects of the operations of 820 may be performed by a transition component as described with reference to FIGS. 5 through 7.

At 825, the analytical data store may store the second thread state in association with the message thread including the new message. The operations of 825 may be performed according to the methods described herein. In some examples, aspects of the operations of 825 may be performed by a state storage component as described with reference to FIGS. 5 through 7.

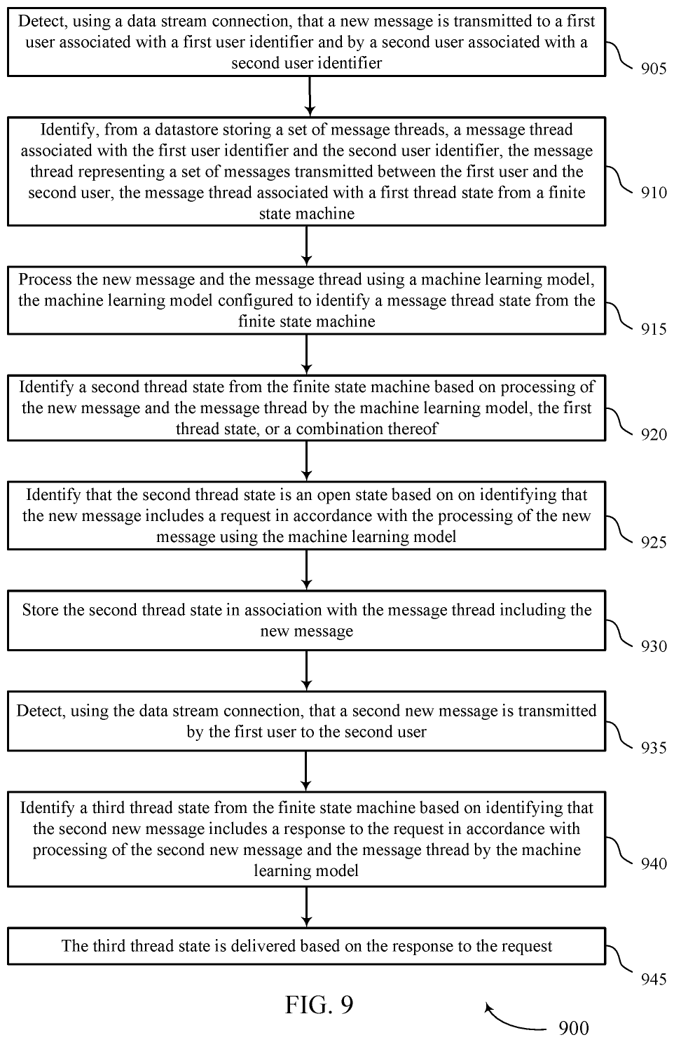

FIG. 9 shows a flowchart illustrating a method 900 that supports identifying message thread state in accordance with aspects of the present disclosure. The operations of method 900 may be implemented by an analytical data store or its components as described herein. For example, the operations of method 900 may be performed by a message thread state manager as described with reference to FIGS. 5 through 7. In some examples, an analytical data store may execute a set of instructions to control the functional elements of the analytical data store to perform the functions described below. Additionally or alternatively, an analytical data store may perform aspects of the functions described below using special-purpose hardware.

At 905, the analytical data store may detect, using a data stream connection, that a new message is transmitted to a first user associated with a first user identifier and by a second user associated with a second user identifier. The operations of 905 may be performed according to the methods described herein. In some examples, aspects of the operations of 905 may be performed by a data stream connection component as described with reference to FIGS. 5 through 7.

At 910, the analytical data store may identify, from a datastore storing a set of message threads, a message thread associated with the first user identifier and the second user identifier, the message thread representing a set of messages transmitted between the first user and the second user, the message thread associated with a first thread state from a finite state machine. The operations of 910 may be performed according to the methods described herein. In some examples, aspects of the operations of 910 may be performed by a message thread identification component as described with reference to FIGS. 5 through 7.

At 915, the analytical data store may process the new message and the message thread using a machine learning model, the machine learning model configured to identify a message thread state from the finite state machine. The operations of 915 may be performed according to the methods described herein. In some examples, aspects of the operations of 915 may be performed by a model component as described with reference to FIGS. 5 through 7.

At 920, the analytical data store may identify a second thread state from the finite state machine based on processing of the new message and the message thread by the machine learning model, the first thread state, or a combination thereof. The operations of 920 may be performed according to the methods described herein. In some examples, aspects of the operations of 920 may be performed by a transition component as described with reference to FIGS. 5 through 7.

At 925, the analytical data store may identify that the second thread state is an open state based on identifying that the new message includes a request in accordance with the processing of the new message using the machine learning model. The operations of 925 may be performed according to the methods described herein. In some examples, aspects of the operations of 925 may be performed by a transition component as described with reference to FIGS. 5 through 7.

At 930, the analytical data store may store the second thread state in association with the message thread including the new message. The operations of 930 may be performed according to the methods described herein. In some examples, aspects of the operations of 930 may be performed by a state storage component as described with reference to FIGS. 5 through 7.

At 935, the analytical data store may detect, using the data stream connection, that a second new message is transmitted by the first user to the second user. The operations of 935 may be performed according to the methods described herein. In some examples, aspects of the operations of 935 may be performed by a data stream connection component as described with reference to FIGS. 5 through 7.

At 940, the analytical data store may identify a third thread state from the finite state machine based on identifying that the second new message includes a response to the request in accordance with processing of the second new message and the message thread by the machine learning model. The operations of 940 may be performed according to the methods described herein. In some examples, aspects of the operations of 940 may be performed by a transition component as described with reference to FIGS. 5 through 7.

At 945, the analytical data store may the third thread state is delivered based on the response to the request. The operations of 945 may be performed according to the methods described herein. In some examples, aspects of the operations of 945 may be performed by a transition component as described with reference to FIGS. 5 through 7.

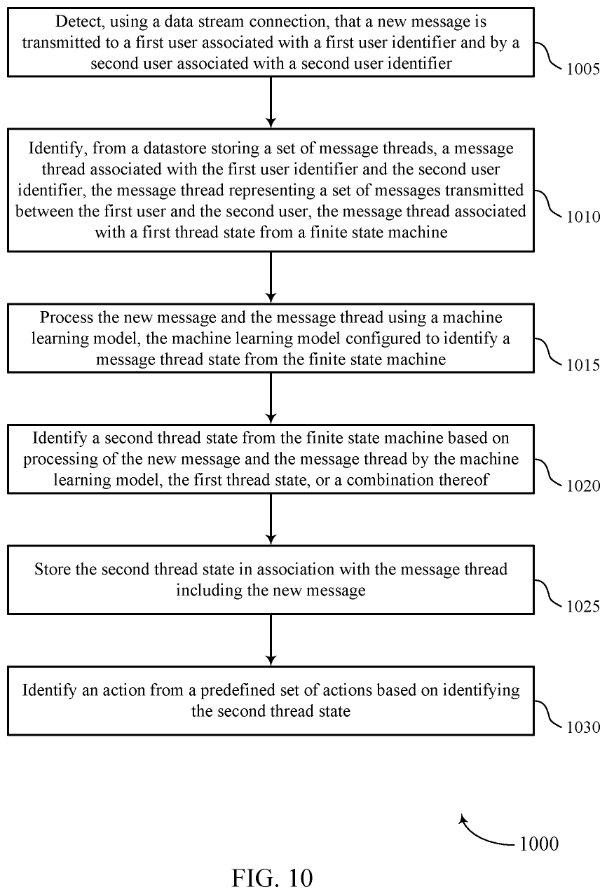

FIG. 10 shows a flowchart illustrating a method 1000 that supports identifying message thread state in accordance with aspects of the present disclosure. The operations of method 1000 may be implemented by an analytical data store or its components as described herein. For example, the operations of method 1000 may be performed by a message thread state manager as described with reference to FIGS. 5 through 7. In some examples, an analytical data store may execute a set of instructions to control the functional elements of the analytical data store to perform the functions described below. Additionally or alternatively, an analytical data store may perform aspects of the functions described below using special-purpose hardware.

At 1005, the analytical data store may detect, using a data stream connection, that a new message is transmitted to a first user associated with a first user identifier and by a second user associated with a second user identifier. The operations of 1005 may be performed according to the methods described herein. In some examples, aspects of the operations of 1005 may be performed by a data stream connection component as described with reference to FIGS. 5 through 7.

At 1010, the analytical data store may identify, from a datastore storing a set of message threads, a message thread associated with the first user identifier and the second user identifier, the message thread representing a set of messages transmitted between the first user and the second user, the message thread associated with a first thread state from a finite state machine. The operations of 1010 may be performed according to the methods described herein. In some examples, aspects of the operations of 1010 may be performed by a message thread identification component as described with reference to FIGS. 5 through 7.

At 1015, the analytical data store may process the new message and the message thread using a machine learning model, the machine learning model configured to identify a message thread state from the finite state machine. The operations of 1015 may be performed according to the methods described herein. In some examples, aspects of the operations of 1015 may be performed by a model component as described with reference to FIGS. 5 through 7.

At 1020, the analytical data store may identify a second thread state from the finite state machine based on processing of the new message and the message thread by the machine learning model, the first thread state, or a combination thereof. The operations of 1020 may be performed according to the methods described herein. In some examples, aspects of the operations of 1020 may be performed by a transition component as described with reference to FIGS. 5 through 7.

At 1025, the analytical data store may store the second thread state in association with the message thread including the new message. The operations of 1025 may be performed according to the methods described herein. In some examples, aspects of the operations of 1025 may be performed by a state storage component as described with reference to FIGS. 5 through 7.

At 1030, the analytical data store may identify an action from a predefined set of actions based on identifying the second thread state. The operations of 1030 may be performed according to the methods described herein. In some examples, aspects of the operations of 1030 may be performed by an action identification component as described with reference to FIGS. 5 through 7.

A method of data processing is described. The method may include detecting, using a data stream connection, that a new message is transmitted to a first user associated with a first user identifier and by a second user associated with a second user identifier, identifying, from a datastore storing a set of message threads, a message thread associated with the first user identifier and the second user identifier, the message thread representing a set of messages transmitted between the first user and the second user, the message thread associated with a first thread state from a finite state machine, processing the new message and the message thread using a machine learning model, the machine learning model configured to identify a message thread state from the finite state machine, identifying a second thread state from the finite state machine based on processing of the new message and the message thread by the machine learning model, the first thread state, or a combination thereof, and storing the second thread state in association with the message thread including the new message.

An apparatus for data processing is described. The apparatus may include a processor, memory coupled with the processor, and instructions stored in the memory. The instructions may be executable by the processor to cause the apparatus to detect, using a data stream connection, that a new message is transmitted to a first user associated with a first user identifier and by a second user associated with a second user identifier, identify, from a datastore storing a set of message threads, a message thread associated with the first user identifier and the second user identifier, the message thread representing a set of messages transmitted between the first user and the second user, the message thread associated with a first thread state from a finite state machine, process the new message and the message thread using a machine learning model, the machine learning model configured to identify a message thread state from the finite state machine, identify a second thread state from the finite state machine based on processing of the new message and the message thread by the machine learning model, the first thread state, or a combination thereof, and store the second thread state in association with the message thread including the new message.

Another apparatus for data processing is described. The apparatus may include means for detecting, using a data stream connection, that a new message is transmitted to a first user associated with a first user identifier and by a second user associated with a second user identifier, identifying, from a datastore storing a set of message threads, a message thread associated with the first user identifier and the second user identifier, the message thread representing a set of messages transmitted between the first user and the second user, the message thread associated with a first thread state from a finite state machine, processing the new message and the message thread using a machine learning model, the machine learning model configured to identify a message thread state from the finite state machine, identifying a second thread state from the finite state machine based on processing of the new message and the message thread by the machine learning model, the first thread state, or a combination thereof, and storing the second thread state in association with the message thread including the new message.

A non-transitory computer-readable medium storing code for data processing is described. The code may include instructions executable by a processor to detect, using a data stream connection, that a new message is transmitted to a first user associated with a first user identifier and by a second user associated with a second user identifier, identify, from a datastore storing a set of message threads, a message thread associated with the first user identifier and the second user identifier, the message thread representing a set of messages transmitted between the first user and the second user, the message thread associated with a first thread state from a finite state machine, process the new message and the message thread using a machine learning model, the machine learning model configured to identify a message thread state from the finite state machine, identify a second thread state from the finite state machine based on processing of the new message and the message thread by the machine learning model, the first thread state, or a combination thereof, and store the second thread state in association with the message thread including the new message.

Some examples of the method, apparatuses, and non-transitory computer-readable medium described herein may further include operations, features, means, or instructions for identifying that the second thread state may be an open state based on identifying that the new message includes a request in accordance with the processing of the new message using the machine learning model.

Some examples of the method, apparatuses, and non-transitory computer-readable medium described herein may further include operations, features, means, or instructions for detecting, using the data stream connection, that a second new message may be transmitted by the first user to the second user, and identifying a third thread state from the finite state machine based on identifying that the second new message includes a response to the request in accordance with processing of the second new message and the message thread by the machine learning model.

In some examples of the method, apparatuses, and non-transitory computer-readable medium described herein, the third thread state may be delivered based on the response to the request.

Some examples of the method, apparatuses, and non-transitory computer-readable medium described herein may further include operations, features, means, or instructions for activating an indication at a client device associated with the first user based on identifying the second thread state.

Some examples of the method, apparatuses, and non-transitory computer-readable medium described herein may further include operations, features, means, or instructions for identifying an action from a predefined set of actions based on identifying the second thread state.

Some examples of the method, apparatuses, and non-transitory computer-readable medium described herein may further include operations, features, means, or instructions for transmitting an indication of the identified action to a client device associated with the first user.

Some examples of the method, apparatuses, and non-transitory computer-readable medium described herein may further include operations, features, means, or instructions for monitoring a time period that the message thread state may be associated with the second thread state.

Some examples of the method, apparatuses, and non-transitory computer-readable medium described herein may further include operations, features, means, or instructions for activating an indication at a client device associated with the first user based on the time period reaching a threshold associated with the second thread state.

In some examples of the method, apparatuses, and non-transitory computer-readable medium described herein, identifying a second thread state from the finite state machine may include operations, features, means, or instructions for identifying that the second thread state may be one of a start state, an open state, a delivered state, and an acknowledged state.

In some examples of the method, apparatuses, and non-transitory computer-readable medium described herein, the new message corresponds to an email, a text message, a social media post, a push notification, a chat service message, a transcribed audio chat message, or a combination thereof.

In some examples of the method, apparatuses, and non-transitory computer-readable medium described herein, the datastore storing the set of message threads stores the message thread state of each of the set of message threads, a time period corresponding to the message thread state, or a combination thereof.

In some examples of the method, apparatuses, and non-transitory computer-readable medium described herein, each of the set of message threads may be generated based on identifying, based on processing of a first message of each of the set of message threads, that the first message may have an open state.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
detecting, using a data stream connection, that a new message is transmitted to a first user associated with a first user identifier and by a second user associated with a second user identifier;
identifying, from a datastore storing a plurality of message threads, a message thread associated with the first user identifier and the second user identifier, the message thread representing a plurality of messages transmitted between the first user and the second user, the message thread associated with a first thread state from a finite state machine;
processing the new message and the message thread using a machine learning model, the machine learning model configured to identify a message thread state from the finite state machine;
identifying a second thread state from the finite state machine based at least in part on processing of the new message and the message thread by the machine learning model, the first thread state, or a combination thereof; and
storing the second thread state in association with the message thread including the new message.

2. The method of claim 1, further comprising:
identifying that the second thread state is an open state based at least in part on identifying that the new message comprises a request in accordance with the processing of the new message using the machine learning model.

3. The method of claim 2, further comprising:
detecting, using the data stream connection, that a second new message is transmitted by the first user to the second user; and
identifying a third thread state from the finite state machine based at least in part on identifying that the second new message comprises a response to the request in accordance with processing of the second new message and the message thread by the machine learning model.

4. The method of claim 3, wherein the third thread state is delivered based at least in part on the response to the request.

5. The method of claim 1, further comprising:
activating an indication at a client device associated with the first user based at least in part on identifying the second thread state.

6. The method of claim 1, further comprising:
identifying an action from a predefined set of actions based at least in part on identifying the second thread state.

7. The method of claim 6, further comprising:
transmitting an indication of the identified action to a client device associated with the first user.

8. The method of claim 1, further comprising:
monitoring a time period that the message thread state is associated with the second thread state.

9. The method of claim 8, further comprising:
activating an indication at a client device associated with the first user based at least in part on the time period reaching a threshold associated with the second thread state.

10. The method of claim 1, wherein identifying a second thread state from the finite state machine comprises:
identifying that the second thread state is one of a start state, an open state, a delivered state, and an acknowledged state.

11. The method of claim 1, wherein the new message corresponds to an email, a text message, a social media post, a push notification, a chat service message, a transcribed audio chat message, or a combination thereof.

12. The method of claim 1, wherein the datastore storing the plurality of message threads stores the message thread state of each of the plurality of message threads, a time period corresponding to the message thread state, or a combination thereof.

13. The method of claim 1, wherein each of the plurality of message threads is generated based on identifying, based on processing of a first message of each of the plurality of message threads, that the first message has an open state.

14. An apparatus for data processing, comprising:
a processor,
memory coupled with the processor; and
instructions stored in the memory and executable by the processor to cause the apparatus to:
detect, using a data stream connection, that a new message is transmitted to a first user associated with a first user identifier and by a second user associated with a second user identifier;
identify, from a datastore storing a plurality of message threads, a message thread associated with the first user identifier and the second user identifier, the message thread representing a plurality of messages transmitted between the first user and the second user, the message thread associated with a first thread state from a finite state machine;
process the new message and the message thread using a machine learning model, the machine learning model configured to identify a message thread state from the finite state machine;
identify a second thread state from the finite state machine based at least in part on processing of the new message and the message thread by the machine learning model, the first thread state, or a combination thereof; and
store the second thread state in association with the message thread including the new message.

15. The apparatus of claim 14, wherein the instructions are further executable by the processor to cause the apparatus to:
identify that the second thread state is an open state based at least in part on identifying that the new message comprises a request in accordance with the processing of the new message using the machine learning model.

16. The apparatus of claim 15, wherein the instructions are further executable by the processor to cause the apparatus to:
detect, using the data stream connection, that a second new message is transmitted by the first user to the second user; and
identify a third thread state from the finite state machine based at least in part on identifying that the second new message comprises a response to the request in accordance with processing of the second new message and the message thread by the machine learning model.

17. The apparatus of claim 16, wherein the third thread state is delivered based at least in part on the response to the request.

18. A non-transitory computer-readable medium storing code for data processing, the code comprising instructions executable by a processor to:
detect, using a data stream connection, that a new message is transmitted to a first user associated with a first user identifier and by a second user associated with a second user identifier;
identify, from a datastore storing a plurality of message threads, a message thread associated with the first user identifier and the second user identifier, the message thread representing a plurality of messages transmitted between the first user and the second user, the message thread associated with a first thread state from a finite state machine;
process the new message and the message thread using a machine learning model, the machine learning model configured to identify a message thread state from the finite state machine;
identify a second thread state from the finite state machine based at least in part on processing of the new message and the message thread by the machine learning model, the first thread state, or a combination thereof; and
store the second thread state in association with the message thread including the new message.

19. The non-transitory computer-readable medium of claim 18, wherein the instructions are further executable to:
identify that the second thread state is an open state based at least in part on identifying that the new message comprises a request in accordance with the processing of the new message using the machine learning model.

20. The non-transitory computer-readable medium of claim 19, wherein the instructions are further executable to:
detect, using the data stream connection, that a second new message is transmitted by the first user to the second user; and
identify a third thread state from the finite state machine based at least in part on identifying that the second new message comprises a response to the request in accordance with processing of the second new message and the message thread by the machine learning model.
